(19) United States
(12) Patent Application Publication
(10) Pub. No.: US 2009/0080773 A1
(43) Pub. Date: Mar. 26, 2009

(54) Image segmentation using dynamic color gradient threshold, texture, and multimodal-merging

(76) Inventors: Mark Shaw, Meridian, ID (US); Ranjit Bhaskar, Portland, OR (US); Luis Garcia Ugarriza, Providence, RI (US); Eli Saber, Webster, NY (US); Vincent Amuso, Rochester, NY (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/858,826

(22) Filed: Sep. 20, 2007

(51) Int. Cl. G06K 9/34

(52) U.S. Cl. 382/173

(57) ABSTRACT

A method for segmenting an image receives the image. The image has a number of pixels and a number of color channels. The image is initially segmented into a number of initial regions at least by dynamically selecting a plurality of seeds within the image using a dynamic color gradient threshold and growing the initial regions from the seeds until the initial regions encompass all the pixels of the image. A texture channel of the image is generated at least by applying an entropy filter to each of a plurality of quantized colors of the image. The initial regions into which the image has been initially segmented are multimodal-merged based on the color channels and the texture channel of the image, to yield a number of merged regions corresponding to segmentation of the image.

### BACKGROUND

Imaging segmentation is an image processing technique used in a wide variety of industries, including medical image analysis, satellite imagery, visual surveillance, and face recognition systems. Image segmentation partitions a digital image into multiple regions based on a homogeneity metric. Each region corresponds to a set of pixels of the digital image, where desirably all the pixels of the digital image are encompassed by the multiple regions as a whole. This low-level abstraction of the image permits high-level semantic operations to be performed with a reduced and relevant set of data.

Existing techniques for color image segmentation include feature-based, edge-based, region-based, and hybrid segmentation approaches. The latter segmentation approach may employ two or more of the feature-based, edge-based, and region-based segmentation approaches. Each of these approaches to segmenting an image has disadvantages, however. Some of the segmentation approaches yield less than optimal image segmentation. Other of the segmentation approaches yield better image segmentation, but at the expense of increased processing time.

### BRIEF DESCRIPTION OF THE DRAWINGS

FIG. 1A is a flowchart of a method for segmenting an image, according to an embodiment of the present disclosure.

FIG. 1B is a flowchart of a method for initially segmenting an image into a number of initial regions, according to an embodiment of the present disclosure, and which can be performed as part of the method of FIG. 1A.

FIG. 1C is a flowchart of a method for generating a texture channel for an image, according to an embodiment of the present disclosure, and which can be performed as part of the method of FIG. 1A.

FIG. 1D is a flowchart of a method for multimodal-merging initial regions into which an initial image has been segmented into merged regions corresponding to final segmentation of the image, according to an embodiment of the present disclosure, and which can be performed as part of the method of FIG. 1A.

FIG. 1E is a flowchart of a method for multimodal-merging initial regions into which an initial image has been segmented into merged regions corresponding to final segmentation of the image, according to an embodiment of the present disclosure, and which is more detailed than but consistent with the method of FIG. 1D.

FIG. 2 is a diagram depicting how a number of colors of an image can be quantized into a lesser number of quantized colors, according to an embodiment of the present disclosure.

### DETAILED DESCRIPTION OF THE DRAWINGS

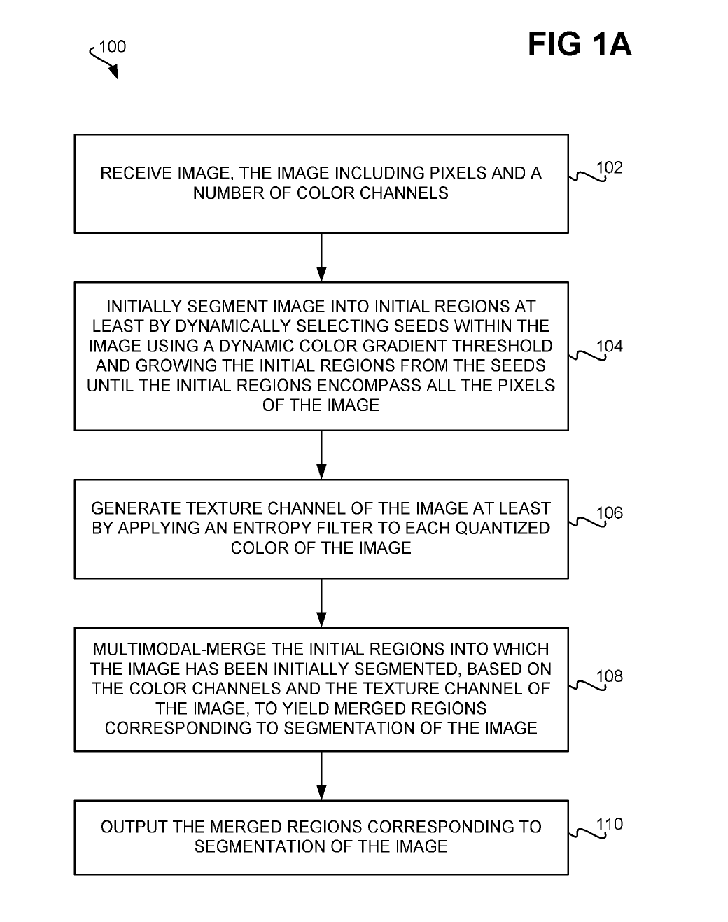

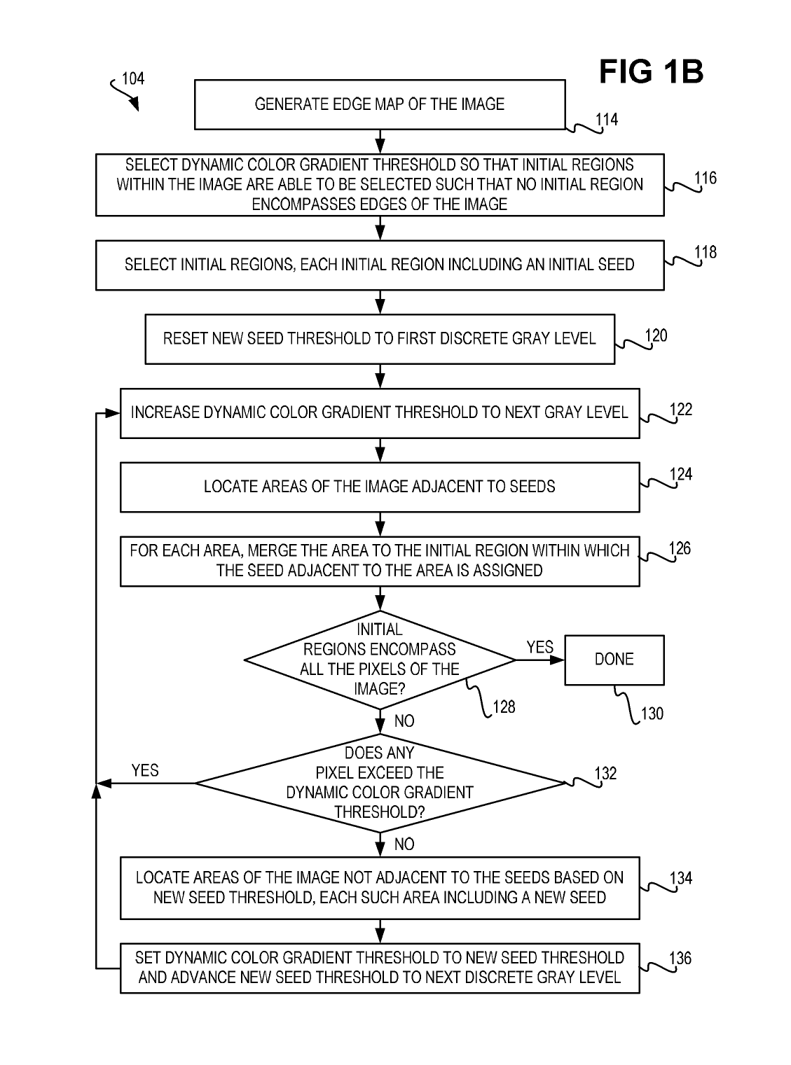

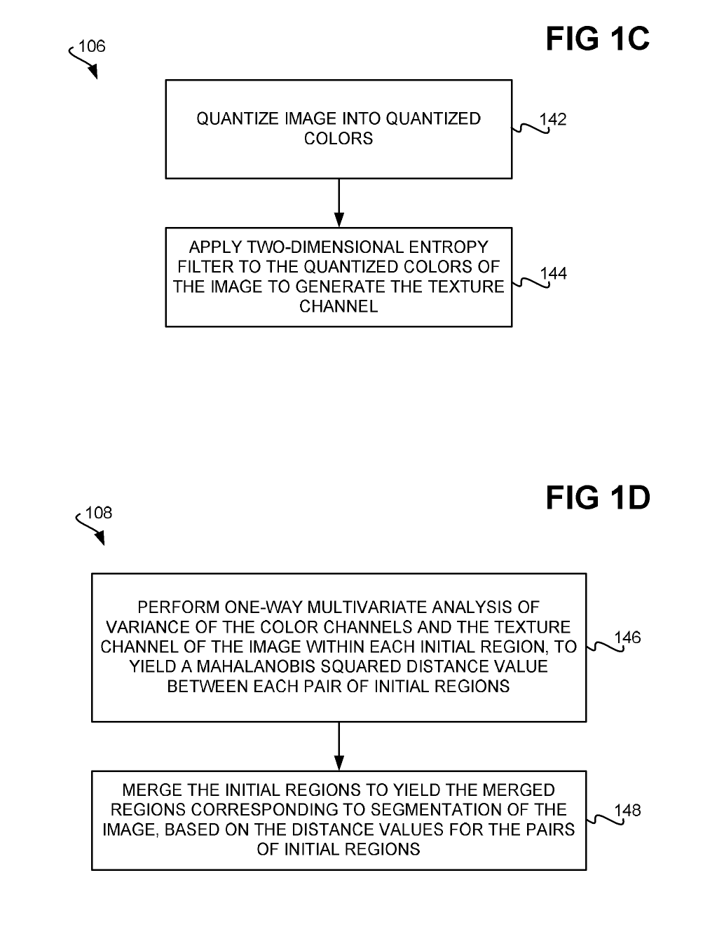

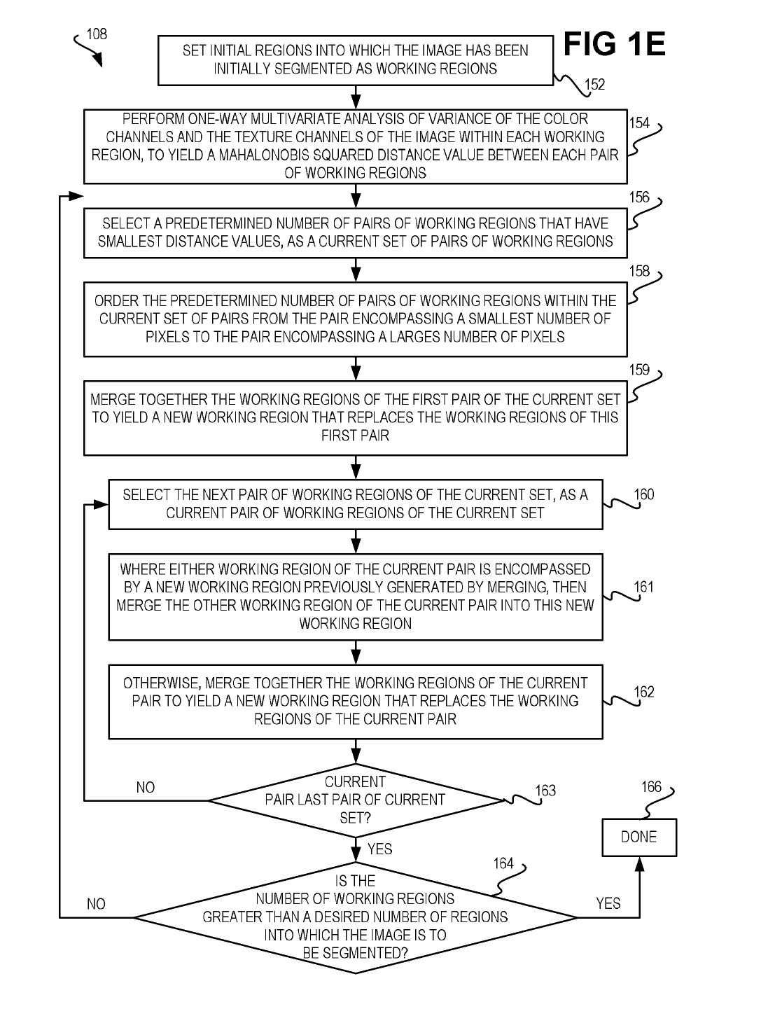

FIG. 1A shows a method 100 for segmenting an image into a number of regions, according to an embodiment of the present disclosure. Like the other embodiments of the present disclosure, the method 100 may be implemented as one or more computer programs. These computer programs may be stored on a computer-readable medium, such as a recordable data storage medium like a hard disk drive, an optical disc, or another type of recordable data storage medium or another type of computer-readable medium. Such computer programs stored on such computer-readable media can include the firmware of embedded systems and devices, such as digital camera firmware, printing device firmware, and so on. In these latter cases, the computer programs may be considered as encompassing the firmware, which are typically stored on solid-state storage media such as semiconductor memories.

The method 100 receives an image (102). In one embodiment, data can be received that corresponds to the image. The image has a number of pixels, and a number of color channels, such as the red, green, and blue color channels, as can be appreciated by those of ordinary skill within the art. Each pixel thus has red, green, and blue color values corresponding to the red, green, and blue color channels of the image. For example, an eight bit image may have red, green, and blue values for each pixel that are between zero and 2⁸−1, or 255.

The method 100 then initially segments the image into a number of initial regions (104). These initial regions are typically relatively small in size and relatively large in number, and are later merged to yield what are referred to as the merged regions to which the final segmentation of the image corresponds. In one embodiment, data can be generated as corresponding to these initial regions. The image is initially segmented into the initial regions at least by dynamically selecting seeds within the image using a dynamic color gradient threshold, and growing the initial regions from these seeds until the initial regions as a whole encompass all the pixels of the image. Such initial segmentation of the image into initial regions is now described in more detail.

FIG. 1B shows a method that can be employed to perform part 104 of the method 100, according to an embodiment of the present disclosure. In at least some embodiments, the method of FIG. 1B can be considered as at least similar to the process described in the pending patent application entitled “Unsupervised color image segmentation by dynamic color gradient thresholding,” filed Apr. 30, 2007, and assigned Ser. No. 11/742,306.

An edge map of the image is generated (114). The edge map is used to define the initial regions that are utilized as a starting point for the remainder of the segmentation of the image. The edge map of the image particularly defines the edges of different features within the image, such as different objects within the image.

In one embodiment, the edge map is generated as follows. It is presumed that the image is a function f(x, y). Therefore, the edges of the image can be defined as the first derivative

$$∇ f = \frac{\partial f}{\partial x} ; \frac{\partial f}{\partial y} .$$

The magnitude of the gradient is select to ensure rotational invariance. For a vector field f the gradient vector can be defined as:

$$D ( x ) = [ \begin{matrix}{D}_{1} {f}_{1} ( x ) & {D}_{2} {f}_{1} ( x ) & ⋯ & {D}_{n} {f}_{1} ( x ) \\ {D}_{1} {f}_{2} ( x ) & {D}_{2} {f}_{2} ( x ) & ⋯ & {D}_{n} {f}_{2} ( x ) \\ ⋮ & ⋮ & ⋮ & ⋮ \\ {D}_{1} {f}_{m} ( x ) & {D}_{2} {f}_{m} ( x ) & ⋯ & {D}_{n} {f}_{m} ( x )\end{matrix} ] \qquad ( 1 )$$

In equation (1), Dⱼfₖ is the first partial derivative of the k^{th} component of f with respect to the j^{th} component of x. The distance map from the point x with a unit vector u in the spatial domain d=\sqrt{u^{T}D^{T} du} will be the corresponding distance traveled in the color domain. The vector that maximizes the given distance is the eigenvector of the matrix D^{T}D that corresponds to its largest eigenvalue.

In the special case of an image having red, green, and blue color channels, which is a color image that can be referred to as an RGB image, the gradient can be determined in the following manner. First, u, v, w denote each color channel and x, y denote the spatial coordinates for a pixel of the image. The following variables are further defined to simplify the expression of the final solution:

$$\begin{matrix}q = {( \frac{d u}{d x} )}^{2} + {( \frac{d v}{d x} )}^{2} + {( \frac{d w}{d x} )}^{2} & ( 2 ) \\ t = ( \frac{d u}{d x} \frac{d u}{d y} ) + ( \frac{d v}{d x} \frac{d v}{d y} ) + ( \frac{d w}{d x} \frac{d w}{d y} ) & ( 3 ) \\ h = {( \frac{d u}{d y} )}^{2} + {( \frac{d v}{d y} )}^{2} + {( \frac{d w}{d y} )}^{2} & ( 4 )\end{matrix}$$

Therefore, the matrix D^{T}D becomes

$${D}^{T} D = [ \begin{matrix}q & t \\ t & h\end{matrix} ] \qquad ( 5 )$$

And its largest eigenvalue λ is

$$λ = \frac{1}{2} ( q + h + \sqrt{{( q + h )}^{2} - 4 ( qh - {t}^{2} )} ) \qquad ( 6 )$$

By calculating λ, the largest differentiation of colors is obtained and the edges of the image can be defined as

G=\sqrt{λ} (7)

Thus, the magnitude of the gradient G(i, j) is used to obtain the edge map of the image.

A dynamic color gradient threshold is selected so that the initial regions within the image are able to be selected such that no initial region encompasses any of the edges of the image (116). The dynamic color gradient threshold corresponds to a discrete gray level of the image when the image is considered in grayscale. That is, and more specifically, the dynamic color gradient threshold is applied to the edge map of the image; it is initially set low to account for areas of the image that include no edges. For example, for a given pixel of the image, there are red, green, and blue color values. However, this pixel also has a grayscale component based on the red, green, and blue color values when the color information of these color values is removed, as can be appreciated by those of ordinary skill within the art. The dynamic color gradient threshold is thus a color gradient threshold in that the grayscale components of the pixels of the image that are compared against this threshold are generated from—i.e., are based on—the color values of the pixels. The color gradient threshold is further dynamic in that as the method of FIG. 1B is performed, the threshold increases, as will be described.

The initial regions are identified by clustering pixels of the image that fall below the dynamic color gradient threshold selected, such that no initial region includes or encompasses any of the edges of the image as defined by the edge map. In one embodiment, the dynamic color gradient threshold is selected in part 116 so that it is the smallest, or lowest, such threshold that permits selection of the initial regions within the image that do not encompass any edges of the image, as defined by the edge map. Once this dynamic color gradient threshold is selected, then, the initial regions are selected, where each initial region includes an initial seed (118).

Because the dynamic color threshold has been selected in part 116 so that no initial region encompasses any of the edges of the images, the initial regions are selected in part 118 so that they do not include any edges of the image. The selection of the initial regions in part 118 is thus constrained by the edge map generated in part 114. The method of FIG. 1B in part 118 can in one embodiment search for pixel clusters within the image where no edges have been detected. As a result, for instance, sky, skin, and other such features within the image may ultimately be selected in part 118 due to their having no strong color variance.

Each initial region is said to include an initial seed, where a seed is also defined as a cluster of one or more pixels of the image. Each initial seed is defined as one of the initial regions, and vice-versa. In one embodiment, to prevent multiple seed generation within homogeneous and connect regions, which should form a single initial region, the initial seeds (i.e., the initial regions prior to their being grown) are selected in part 118 as clusters of pixels that are larger than 0.5%, or another predetermined percentage, of the image.

Each such individual cluster of pixels is assigned a particular label for differentiation purposes, and this resulting label map is referred to as the parent seeds, or PS, map. Thus, the initial seeds correspond to these individual clusters of pixels. In one embodiment, as can be appreciated by those of ordinary skill within the art, the labeling process may be performed by run-length encoding the image, and then scanning the runs to assign preliminary labels and to record label equivalences in a local equivalence table. Thereafter, the equivalence classes are resolved, and the runs relabeled based on the resolved equivalence classes.

Prior to growing the initial regions corresponding to the initial seeds, the method of FIG. 1B resets a new seed threshold that will later be used to introduce new seeds on which basis initial regions are grown (120). The new seed threshold is also a dynamic color gradient threshold, but is specifically one that is advanced over a series of discrete gray levels, such as {15, 20, 30, 50, 85, 120}, which is more particularly described later in the detailed description in relation to part 136 of the method of FIG. 1B. Thus, in part 120, the new seed threshold is reset to the first discrete gray level of 15. When the new seed threshold is advanced, it is advanced to the next discrete gray level, such as from 15 to 20, from 20 to 30, and so on.

Next, the initial regions that have been identified are grown to include more pixels of the image. Specifically, the dynamic color gradient threshold, originally selected in part 116, is increased by one gray level (122), such as from 15 to 16, from 16 to 17, and so on. Areas of the image that are adjacent to the seeds are located (124). That is, for each seed that has been assigned to an initial region, an area of the image that is adjacent to the image is located. Each area is then merged to the initial region to which the seed adjacent to the area in question has been assigned (126). In this way, the initial regions are “grown” to encompass other portions of the image that are not initially part of these seeds. In particular, it is noted that such region growth does not depend exclusively on the initial assignment of clusters (i.e., the initial seeds) for the final segmentation of the image. The “seeds referred to in part 126 are existing seeds, and at first include just the initial seeds that have been determined in part 118, but subsequently include additional (new) seeds that are generated when part 134 is performed, as is described in more detail later in the detailed description.

In one embodiment, determining the areas of the image that are adjacent to the seeds and merging these areas to the initial regions to which the seeds have been assigned can be achieved as follows. Child seeds are selected that fall below the dynamic color gradient threshold, which was previously advanced to the next discrete gray level in part 122. These child seeds are classified into adjacent to existing seeds and non-adjacent to existing seeds. It can thus be important to know the existing seed to which each such child seed is adjacent. The object in this sense is to be able to process all the adjacent child seeds in a vectorized approach.

To achieve this task, the outside edges of the PS map that has previously been generated are detected, using a nonlinear spatial filter. The filter operates on the pixels of an n×n neighborhood, such as a 3×3 neighborhood, and the response of its operation is assigned to the center pixel of the neighborhood. The filter operates according to

$$F ( i , j ) = \{ \begin{matrix}0 & if PS ( i , j ) > 0 \\ 0 & if {\sum }_{( m , n ) ∈ β} PS ( m , n ) = 0 \\ 1 & otherwise\end{matrix} \qquad ( 8 )$$

In equation (8), β is the neighborhood being operated on. The result of applying this filter is a mask indicating the borders of the PS map.

The child seeds are individually labeled and the ones adjacent to the existing seeds are identified by performing an element-by-element multiplication of the parent seeds edge mask and the labeled child map. The remaining pixels are referred to as the adjacent child pixels, and the pixels of which labels are members to the set of labels remaining after the multiplication become part of the adjacent child seeds map. For the proper addition of adjacent child sets, their individual color differences may be compared to their parent seeds to assure homogeneous segmentation. Reduction of the number of seeds to be evaluated is achieved by attaching to the existing (parent) seeds the child seeds that have a size smaller than the minimum seed size, or MSS. In one embodiment, MSS may be set to 0.01% of the image.

The child seed sizes are determined utilizing sparse matrix storage techniques, as can be appreciated by those of ordinary skill within the art, to provide for the creation of large matrices with low memory costs. Sparse matrices store just their nonzero elements, together with the location of these nonzero elements, which are referred to as indices. The size of each child seed is determined by creating a matrix of M×N columns by C rows, where M is the number of columns of pixels within the image itself, N is the number of rows of pixels within the image, and C is the number of adjacent child seeds. The matrix is created by allocating a one at each column in the row that matches the pixel label. Pixels that do not have labels are ignored. By summing all the elements along each row, the number of pixels per child seed is obtained.

To attach regions together, an association between child seeds and their existing parent seeds may be needed. The adjacent child pixels provide the child labels, but not the parent labels. Another spatial filter is applied to the PS map to obtain the parent labels. The filter response at each center point is equal to the maximum pixel value in its neighborhood. The association between a child seed and its existing parent seed can then be obtained by creating a matrix with the first column composed of the adjacent child pixels, and the second column with the labels found at the location of the adjacent child pixels in the matrix obtained after applying the maximum value filter to the PS map. It is noted that the use of non-linear filters can provide information about the seeds without directly manipulating the image, such that the final image segmentation is not affected.

The functionality of the association matrix is manifold. It provides the number of child pixels that are attached to existing parent seeds, and also identifies which child seeds share edges with more than one existing parent seed. Child seeds smaller than MSS can now be directly attached to their existing parent seeds. Child seeds that share less than a predetermined number of pixels with their parent seeds, such as five pixels, and that are larger than MSS are returned to the un-segmented region to be processed when the region shares a more significant border. The remaining child seeds are compared to their parent seeds to analyze if they should be added or not.

Given that regions in images vary spatially in a gradual manner, just the nearby area of adjacency between a parent seed and a child seed is compared to provide a true representation of the color difference. This objective can be achieved by using two masks that exclude the areas of both parent seeds and child seeds that are distant from their common boundaries. The first mask is a dilation of the PS map using an octagonal structuring element with a distance of a predetermined number of pixels, such as 15 pixels, between the center pixel to the sides of the octagon, as measured along the horizontal and vertical axes. The second mask is the same dilation, but applied to the adjacent child seeds map. The two masks exclude mutually the pixels that fall beyond each other's dilation masks. In one embodiment, such masks where the distance is set to 15 pixels has been found to perform well for images that are 300-by-300 pixels in size to images that are 1,000 pixels-by-11000 pixels in size.

The comparison of regions can be performed using the Euclidean distance between the mean colors of the clusters, or areas, being compared. In one embodiment, prior to this comparison being performed, the image may be converted to the CIE L*a*b color space, as known within the art, to assure that comparing colors using the Euclidean distance is similar to the differentiation of colors by the human visual system. The maximum color distance to allow the integration of the child seed to the parent seed in one embodiment is set to 20. This distance is selected more generally to allow the differentiation of at least a number of different colors, such as ten different colors, along the range of the a* channel or the b* channel.

At some point, the initial regions are sufficiently grown to encompass all the pixels of the image (128), at which time the method of FIG. 1B is finished (130). Before that point is reached, however, it is determined whether any pixel of the image exceeds the dynamic color gradient threshold (132). If so, then the method of FIG. 1B is repeated at part 122, which may be considered a reentry point of the method of FIG. 1B in the sense that the method is “reentered at part 122. Repeating the method at part 122 ensures that all the existing seeds are processed by growing adjacent areas to the regions of which the existing seeds are a part.

If all the initial regions still do not encompass all the pixels of the image however (128), and all the existing seeds have been processed such that the dynamic color gradient threshold is not exceeded for any existing pixel (132), then the method of FIG. 1B introduces new seeds to add to the already existing set of seeds. In particular, areas of the image are located that are not adjacent to the presently existing seeds (134), where each such new area is said to at least include a new seed in the same way in which each initial region included an initial seed in part 118. These new pixel clusters—i.e., the new seeds—may account for other objects and features that are found within the image in question. Dynamic seed generation is based on the new seed threshold, in that the areas located in part 134, and thus the new seeds identified in part 134, do not encompass any edges of the image in relation to the new seed threshold.

The new areas that are detected in part 134 are selected so that they fall below the value of the new seed threshold. All such regions that are not attached to any existing seeds and are larger than MSS are added to the PS map. Furthermore, new seeds that share borders with existing seeds may still be added provided that they represent areas large enough to become initial regions by themselves, and that the color differences between such areas and their neighbors is greater than the maximum color difference allowed for defining a single region.

It is noted that region growth without feedback of the growth rate of each current may cause existing seeds to overflow into regions of similar colors, but different textures. Each region in an image may display similar density throughout the region. Therefore, to maintain homogeneity, the regions that are created at low gradient levels after the growth rate has stabilized are classified as a grown seeds and removed from the growth process. As such, size tracking of each seed may be performed each time new (i.e., dynamic) seeds are added. The number of pixels per seed is thus determined at each such interval, and when the increment of a given existing seed does not reach about a predetermined percentage of its original size, such as 5%, the growth of the seed is stopped. When the last interval has been reached, all the identifiable regions have been provided a label, and all remaining areas are edges of the segmented regions. At this stage, then, all the seeds may nevertheless be allowed to grow to complete the region growth process.

Next, the method of FIG. 1B sets the dynamic color gradient threshold to the new seed threshold, and advances the new seed threshold to the next discrete level in the aforementioned series of discrete gray levels (136), before repeating at the reentry point of part 122. The new seed threshold is adjusted in this manner to account for the exponential decay of edge values, where ranges in the low edge values account for larger areas in the image. To incorporate new areas, the new seed threshold is incremented exponentially to include additional elements of considerable size into the segmentation map. In one embodiment, each discrete gray level of the series {15, 20, 30, 50, 85, 120} accounts for an addition of ±10%, or another percentage, of the image being added.

Referring back to FIG. 1A, besides the initial segmentation of the image into initial regions in part 104, a texture channel of or for the image is generated (106). Part 106 may be performed in unison with part 104, before part 104 is performed, or after part 104 is performed. In one embodiment, data can be generated as corresponding to the texture channel of the image. The texture channel of the image specifies the texture of the image, and can be generated at least by applying an entropy filter to the quantized color channel of the image. Such texture channel generation is now described in more detail.

FIG. 1C shows a method that can be employed to perform part 106 of the method 100, according to an embodiment of the present disclosure. It is noted that many problems in image segmentation are caused by the presence of regions that contain distinct patterns. The issue is that patterns are composed of multiple shades of color and cause over-segmentation and misinterpretation of the edges surrounding the patterned feature in question. These features are referred to as textures. Textured region may contain regular patterns such as a brick wall, as well as irregular patterns such as leopard skins, bushes, and other features found in nature. Because the presence of texture within images is relatively large and descriptive of the features within these images, the method of FIG. 1C is employed to generate an additional texture channel containing this information of the image.

The colors of an image are quantized into a number of quantized colors (142). For example, an eight bit image has 2⁸, or 256, colors for each of its red, green, and blue color channels. Each color channel can have its values represented as a number of quantized ranges: {0 . . . a}, {a+1 . . . b}, . . . {m+1 . . . n}. For an eight bit image, the 256 colors of each color channel can be represented as number of quantized ranges: {0 . . . 51}, {52 . . . 102}, {103 . . . 153}, {154 . . . 204}, {205 . . . 255}. As such, the values of a given color channel that are in the first range are assigned to the first quantized color, the values between 52 and 102 are quantized to the second quantized color, the values of a given color channel between 103 and 153 are quantized to the third quantized color, and so on. Furthermore, because each pixel of the image has three color values (r, g, b) corresponding to the red, green, and blue color channels of the image, each pixel of an eight bit image for which there are five quantized ranges for each color channel can be quantized into one of 5³=125 different quantized colors.

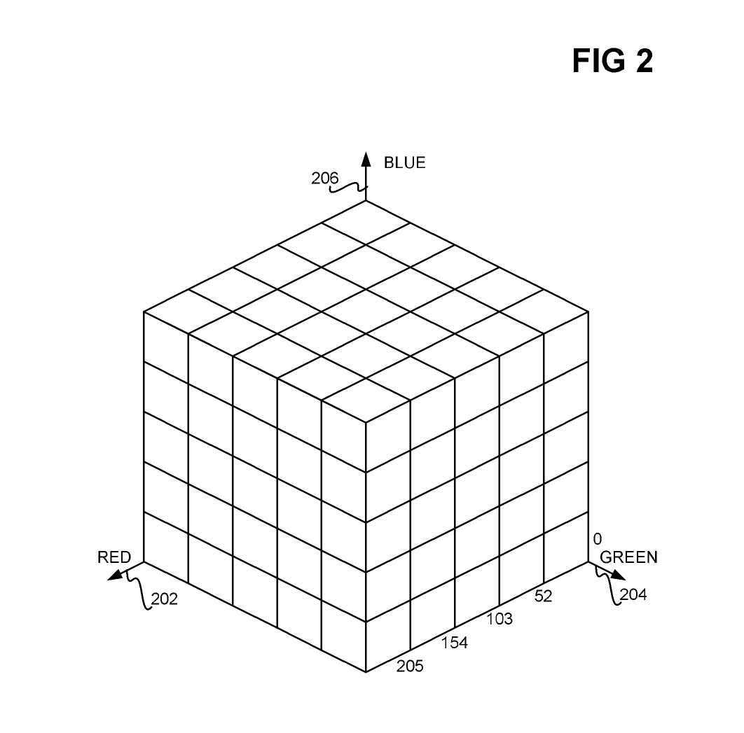

FIG. 2 shows such a representative quantization of the colors of an image pixel, according to an embodiment of the present disclosure. Each of the colors red, green, and blue lie on a different axis 202, 204, and 206, respectively. The origin of each axis is zero, and each other cube boundary along a given axis corresponds to the first color value that is within a successive quantized range of the color channel to which the axis corresponds. For example, as to the red color channel, the five leading edges of the cube boundaries that intersect the axis 202 correspond to the five red color values 0, 52, 103, 154, 205, as depicted in FIG. 2. Because the same relationship holds for the green and the blue color values, there are thus 5³=125 different quantized colors represented within the quantization of FIG. 2. In another embodiment, however, the colors may be quantized into Mⁿ different quantized colors, such as 6³=216 different quantized colors as just one example.

Referring back to FIG. 1C, once the image has been quantized, a two-dimensional entropy filter is applied to the quantized color values of the pixels of the image, to generate the texture channel of the image (144). It is noted that in this respect one approach for obtaining information regarding patterns, or textures, within an image is to evaluate the randomness present within the image. Entropy provides a measure of uncertainty of a random variable. If the random variable includes pixel values of a given region, the entropy will define the randomness associated to this region. Texture regions contain various colors and shades, such that texture regions contain a specific value of uncertainty associated with them, which provides a structure to later merge regions that display similar characteristics.

Entropy is defined as a quantity in information theory, as can be appreciated by those of ordinary skill within the art. Therefore, a random group of pixels s can be selected from an image, with a set of possible values {a₁, a₂, . . . aⱼ}. The probability for a specific value aⱼ to occur is P(aⱼ), and it contains

$$l ( {a}_{j} ) = log \frac{1}{P ( {a}_{j} )} = - log P ( {a}_{j} ) \qquad ( 9 )$$

units of information. The quantity l(aⱼ) is referred to as the self-information of aⱼ. If k values are presented within the set, the law of large numbers stipulates that the average of a random value aⱼ is likely to be closed to the average of the whole set. Thus, the average self-information obtained from k inputs is

−kP(a₁) log P(a₁)− . . . −kP(aⱼ)log P(aⱼ) (10)

Furthermore, the average information per sample, or entropy of the set, is defined by

$$H ( s ) = - {\sum }_{j = 1}^{J} p ( {a}_{j} ) log P ( {a}_{j} ) \qquad ( 11 )$$

This quantity is defined for a single random variable. However, in relation to the image that is the subject of the method 100, multiple variables are being worked with. Therefore, to take advantage of the color information without extending the process to determine the joint entropy, this is why the colors in the image have been quantized. This quantization of colors can be achieved in part 142 by dividing the RGB color cube of FIG. 2 into sub-cubes, and then mapping all colors that fall within sub cube to a pre-specified color. After the colors have been quantized, each pixel of the image can be indexed to one of these representative quantized colors, as has been described. This effectively reduces the probability of each color occurring to a one-dimensional random variable. To create the texture channel in part 142, then, the local entropy is determined on an n-by-n neighborhood around each pixel within the image, by applying the entropy filter of equation (11), where n may be nine in one embodiment. The resulting value is assigned to the center pixel of the neighborhood.

Referring back to FIG. 1A, once the initial segmentation of the image into initial regions has been performed in part 104 and a texture channel of the image has been generated in part 106, these initial regions are multimodal-merged based on the color channels of the image and the texture channel of the image (108). The result is a number of what are referred to as merged regions of the image, where each merged regions includes one or more of the initial regions merged together. The merged regions correspond to the final segmentation of the image. In one embodiment, data can be generated as corresponding to the merged regions. The initial regions are referred to as being “multimodal-merged in that more than one—and specifically two—types of “modes” are considered when merging the initial regions into the merged regions to yield the final segmentation of the image: the color channels of the image, and the texture channel of the image. Such multimodal-merging is now described in more detail.

FIG. 1D shows a general method that can be employed to perform part 108 of the method 100, according to an embodiment of the present disclosure. In particular, a one-way multivariate analysis of variance of the color channels and the texture channel of the image is performed in relation to each initial region (146). The result of this one-way multivariate analysis is a distance value, such as a Mahalanobis squared distance value, as can be appreciated by those of ordinary skill within the art, between each unique pair of initial regions. The distance value between each pair of initial regions specifies the difference between the two initial regions in question. As such, a low distance value between two initial regions is indicative of these regions being more similar, and a high distance value is indicative of these regions being more different.

To describe how one-way multivariate variance analysis can be performed, the more basic one-way variance analysis is described, and those of ordinary skill within the art can appreciate that one-way multivariate variance analysis just extends such one-way variance analysis, as is described herein as well. The general case in which p variables x₁, x₂, . . . xₚ are measured on each individual group is considered, in any direction in the p-dimensional sample of the groups that is specifies by the p-tuple (a₁, a₂, . . . aₚ). Each multivariate observation x′ⱼ=(xⱼ₁, xⱼ₂, . . . , xᵢₚ) can be converted into a univariate observation yᵢ=a′xᵢ where a′=(a₁, a₂, . . . aₚ). Because the samples are divided into g separate groups, it is useful to relabel each element using the notation yᵢⱼ, where i refers to the group that the element belongs to, and j is the location of the element on the i^{th} group.

The objective of one-way variance is to locate the optimal coefficients of the vector a that will yield the largest differences across groups and minimize the distances of elements within the group. To achieve this, the between-groups sum-of-squares and products matrix B₀ and the within-groups sum-of-squares and products matrix W₀ are defined by

$$\begin{matrix}{B}_{0} = \sum {n}_{i} ( {\overline{x}}_{i} - \overline{x} ) {( {\overline{x}}_{i} - \overline{x} )}^{′} & ( 12 ) \\ and & \\ {W}_{0} = {\sum }_{l = 1}^{g} {\sum }_{j = 1}^{{n}_{i}} ( {x}_{ij} - {\overline{x}}_{i} ) {( {x}_{ij} - {\overline{x}}_{i} )}^{′} & ( 13 )\end{matrix}$$

In equations (12) and (13) the labeling xy is analogous to that of

$${y}_{ij} \cdot {\overline{x}}_{i} = \frac{1}{{n}_{i}} {\sum }_{i = 1}^{g} {x}_{ij}$$

is the sample mean vector in the i^{th} group and

$${\overline{x}}_{i} = \frac{1}{{n}_{i}} {\sum }_{i = 1}^{g} {\sum }_{j = 1}^{{n}_{i}} {x}_{ij} = \frac{1}{n} {\sum }_{j = 1}^{g} {n}_{i} {\overline{x}}_{i}$$

is the overall sample mean vector. Since yᵢⱼ=a′xᵢⱼ, it can be verified that the sum of between-groups and within-groups becomes

SSB(a)=a′B₀a and SSW(a)=a′W₀a (14)

With n sample members and g groups, there are (g−1) and (n−g) degrees of freedom between and within groups respectively. A test of the null hypothesis that there are no differences in mean value among the g groups is obtained from the mean square ratio

$$F = \frac{\{ \frac{1}{( g - 1 )} {a}^{′} {B}_{0} a \}}{\{ \frac{1}{( n - g )} {a}^{′} {W}_{0} a \}} = \frac{{a}^{′} Ba}{{a}^{′} Wa} \qquad ( 15 )$$

In equation (15), B is the between-group covariance matrix and W is the within-groups covariance matrix. Maximizing F with respect to a is done by differentiating F and setting the result to zero, yielding

$$Ba - ( \frac{{a}^{′} Ba}{{a}^{′} Wa} ) Wa = 0.$$

However, at the maximum of

$$F , ( \frac{{a}^{′} Ba}{{a}^{′} Wa} )$$

has to be a constant I, so the required value of a has to satisfy

(B−/W)a=0 (16)

Equation (16) can be rewritten as (W⁻¹B−/I)a=0, so / has to be an eigenvalue, and a has to be the eigenvector corresponding to the largest eigenvalue of W⁻¹B. This result provides the direction in the p-dimensional data space, which tends to keep the distances between each class small, and simultaneously maintains the distances between classes as large as possible.

In the case where g is large, or if the original dimensionality is large, a single direction provides a gross over-simplification of the true multivariate configuration. The term in equation (16) generally possesses more than one eigenvalue/eigenvector pair that can be used to generate multiple differentiating directions. Suppose that λ₁λ₂> . . . λₛ>0 are the eigenvalues associated with the eigenvectors a₁, a₂, . . . , aₛ. If new variates y₁, y₂, . . . by yᵢ=a′ᵢx are defined, then the yᵢ are termed canonical variates.

Thus, all the eigenvalues λₜ and eigenvectors aᵢ are gathered together so that aᵢ is the i^{th} column of a (p×s) matrix A, while λₜ is the i^{th} diagonal element of the (s×s) diagonal matrix L. Then, in x terms equation (16) may be written as BA=WAL, and the collection of canonical variates is given by y=A′x. The space of all vectors y is termed the canonical variate space. In this space, the mean of the i^{th} group of individuals is y̅ₜ=A′ x̅ᵢ.

Now, the Mahalanobis squared distance between the i^{th} and j^{th} group is given by

D²=( x̅ᵢ− x̅ⱼ)′W⁻¹( x̅ᵢ− x̅ⱼ) (17)

Comparing equation (13) to the Euclidean distance of the group means in the canonical variate spaces, and substituting for y̅ᵢ and y̅ⱼ yields

$$\begin{matrix}{d}^{2} = {( {\overline{y}}_{i} - {\overline{y}}_{j} )}^{′} ( {\overline{y}}_{i} - {\overline{y}}_{j} ) \\ = {( {\overline{x}}_{i} - {\overline{x}}_{j} )}^{′} {AA}^{′} ( {\overline{x}}_{i} - {\overline{x}}_{j} )\end{matrix} \qquad ( 18 )$$

However, it can be proven that AA′≡W⁻¹. Thus, substituting for AA′ above yields equation (17). As such, by constructing the canonical variate space in the way described, the Euclidean distance between the group means is equivalent to the Mahalanobis distance of the original space. Obtaining the Mahalanobis distance between groups is beneficial, because it accounts for the covariance between variables as well as of differential variances and is a good measure of distance between two multivariate populations.

It is noted that the segmentation performed in the method 100 up to this point has been performed with an absence of information regarding the individual initial regions. Now that the image has been segmented into the different initial regions, information can be gathered from each individual initial region. There are four sources of information, the red, green, and blue color channels, and the texture channel. There are also individual initial regions having different numbers of pixels. This data can be modeled using an (N*P) matrix, where N is the total number of pixels within the image, and P is the total number of variables that contain information about each pixel. Thus, where G is the total number of initial regions into which the image has been already segmented, then the matrix is composed of G separate sets. As such, a mean value for each individual region is obtained and the result used to compare the different individual regions. This is achieved by performing one-way multivariate analysis of variance of the color channels and the texture channel of the image within each initial region in part 146, as such one-way multivariate analysis has been described above.

From this one-way analysis, the Mahalanobis squared distance values for the pairs of initial regions are obtained. Still referring to FIG. 1D, once such a distance value between each pair of initial regions has been determined based on the color channels and the texture channel of the image, the initial regions are merged to yield the merged regions corresponding to the final segmentation of the image (148). Such merging is achieved based on the distance values, such as the Mahalanobis square distances values that have been generated in part 146. That is, the distance values measure the similarity of two groups, where the smaller the distance, the more similar the two groups are to one another. Thus, the terminology distance values can also be referred to herein as similarity values, where Mahalanobis square distance values are a type of such similarity values.

In general, the individual regions of the pair of initial regions having the smallest, or lowest, distance value are merged together. One-way multivariate analysis of variance is then performed in relation to this new merged region and the other initial regions that were not merged together. The individual regions of the pair of regions having the smallest distance value are again merged together, and one-way multivariate analysis of variance is again performed in relation to the new merged region and the other regions that were not merged together. This iterative process continues until the number of regions is no longer greater than a predetermined number of regions into which the image is desired to be segmented. In one embodiment, for instance, the number of regions into which an image is desired to be segmented, may be selected by the user.

However, this iterative process can be computationally taxing, because one-way multivariate variance analyses are performed each time two regions are merged together. This is because once a region has been merged with another region, the similarity of this newly merged region to the other regions is unknown, but needed if the newly merged region is to be merged with other regions later. Therefore, in one embodiment, an alternative approach is employed to prevent the Mahalanobis distance values from having to be reevaluated after each region merging has occurred, as is now described in detail.

FIG. 1E shows such another method that can be employed to perform part 106 of the method 108, according to an embodiment of the invention. The method of FIG. 1E is consistent with but more detailed than the method of FIG. 1D. In particular, the method of FIG. 1E may be considered in total as performing both parts 146 and 148 of the method of FIG. 1D in one embodiment. More specifically, the method of FIG. 1E provides for the merging of regions to yield the final segmentation of the image without having to reevaluate the Mahalanobis distance values after each particular merging of regions occurs.

First, the initial regions into which the image has already initially been segmented are referred to as working regions (152), for descriptive convenience and clarity. Thereafter, one-way multivariate analysis of the variance of the color channels and the texture channel of the image is performed for or within each working region (154), as has been described in relation to part 146. The result is that there is a Mahalanobis square distance value, or another type of distance value, between or for each pair of working regions.

Thereafter, a predetermined number of pairs of working regions is selected (156), is referred to as a current set of pairs of working regions for descriptive clarity and convenience. This predetermined number of pairs of working regions has the smallest or lowest distance values of all the pairs of working regions. In one embodiment, the predetermined number may be five, which has been found to be an adequate number of pairs of working regions to reduce computational time, while still adequately if not optimally merging working regions together. That is, as will be described and as will become apparent later in the detailed description of FIG. 1E, the one-way multivariate analysis is performed in part 154 not after each time the regions of a given pair have been merged, but rather after each time at least the predetermined number of regions have been merged. As such, the number of times multivariate analysis multivariate analysis has to be performed is lessened, resulting in a performance boost of the method 100 as a whole.

The pairs of working regions within the current set are ordered from the pair of working regions within the current set that encompasses a smallest number of pixels (i.e., the first pair) to the pair of working regions within the current set that encompasses a largest number of pixels (i.e., the last pair) (158). The working regions of the first pair of the current set are merged together (159), to yield a new working region that replaces both the working regions of this first pair. The next pair of working regions within the current set is then selected (160), and referred to as the current pair of working regions of the current set, for descriptive convenience and clarity.

If either working region of the current pair of working regions is encompassed by a new working region previously generated by merging, then the other working region of this current pair is merged into this new working region if the other working region is already not part of this new working region(161). For example, the current pair of working regions may include working regions a and b. There may be one new working region c that was previously generated. Therefore, in part 161, if a is part of c already, then the working region b is added to the new working region c if the working region b is not already part of c. However, if neither working region of the current pair of working regions is encompassed by a new working region previously generated by merging, then these two working regions are merged together (162), to yield another new working region that replaces both the working regions of this current pair.

If the current pair is not the last pair of the current set of pairs of working regions (163), then the method of FIG. 1E is repeated at part 160, which is referred to as a reentry point of the method of FIG. 1E. As such, each pair of the current set of pairs of working regions is processed after a one-way multivariate analysis of variance has been performed in part 152. Once the current pair is the last pair of the current set of pairs of working regions (163), the method of FIG. 1E determines whether the number of working regions is greater than the desired number of regions into which the image is to be segmented as a result of performing the method 100 (164). If the number of working regions is less than or equal to this desired number of regions, then the method of FIG. 1E is finished (166), such that the working regions that still remain are the merged regions of the final segmentation of the image. However, if the number of working regions is not yet less than or equal to the desired number of regions, the method of FIG. 1E is repeated at part 154 as a reentry point.

Therefore, in the method of FIG. 1E, a one-way multivariate analysis of variance is not performed each time two regions are merged into a new region. Rather, once a one-way multivariate analysis of variance is performed in part 154, a predetermined number of pairs of regions is merged by performing parts 159, 161, and 162, prior to another multivariate analysis being performed in part 154. As such, the method of FIG. 1E can be computationally more efficient and be performed more quickly than if a one-way multivariate analysis were performed after each time two regions were merged.

Therefore, referring back to FIG. 1A, once the initial regions have been multimodal-merged into a number of merged regions in part 108, the segmentation of the image is complete. The merged regions resulting from performance of part 108 represents the final segmentation of the image. It is noted that the process of the method 100 is such that a relatively large number of initial regions are first grown, and then merged together based on color channel and texture channel information of the image itself to yield these merged regions.

The method 100 can conclude in one embodiment by outputting the merged regions that have been generated as the segmentation of the image in question (110). For example, in one embodiment, this segmentation may be stored on a computer-readable medium, for subsequent processing by one or more other computer programs. As another embodiment, the segmentation may be displayed on a display device for a user to view the merged regions. As a third example, the merged regions may be transmitted over a network to a computing device other than that which performed the method 100, so that this other computer device can perform further processing on the image in question as segmented into the merged regions. These and other examples are all encompassed by the phrase that the merged regions into which the image has been segmented are output.

It is finally noted that the image segmentation approach that has been described herein has been found to provide satisfactory, good, and/or optimal results for a wide variety of different color images. Furthermore, and just as advantageous, is that the image segmentation approach is performed relatively quickly even with modest computing power. As such, embodiments of the present disclosure are advantageous because they provide both good results and fast processing time to generate these results.

We claim:

1. A method for segmenting an image comprising:
receiving the image, the image having a plurality of pixels and a plurality of color channels;
initially segmenting the image into a plurality of initial regions at least by dynamically selecting a plurality of seeds within the image using a dynamic color gradient threshold and growing the initial regions from the seeds until the initial regions encompass all the pixels of the image;
generating a texture channel of the image at least by applying an entropy filter to each of a plurality of quantized colors of the image; and,
multimodal-merging the initial regions into which the image has been initially segmented based on the color channels and the texture channel of the image, to yield a plurality of merged regions corresponding to segmentation of the image.

2. The method of claim 1, wherein receiving the image comprises receiving first data corresponding to the image, the pixels of the image, and the color channels of the image,
wherein initially segmenting the image into the initial regions comprises generating second data corresponding to the initial regions,
wherein generating the texture channel of the image comprises generating third data corresponding to the texture channel
wherein multimodal merging the initial regions to yield the merged regions comprises generating fourth data corresponding to the merged regions, and
wherein the method further comprises outputting the merged regions corresponding to segmentation of the image by outputting the fourth data generated.

3. The method of claim 1, wherein the dynamic color gradient threshold is increased over a plurality of gray levels during initial segmentation of the image into the initial regions.

4. The method of claim 1, wherein initially segmenting the image into the initial regions comprises:
generating an edge map of the image;
selecting the dynamic color gradient threshold so that the initial regions are able to be selected such that no initial region encompasses any edges of the image as defined by the edge map;
selecting the initial regions of the image, each initial region being an initial seeds such that there is a plurality of initial seeds.

5. The method of claim 4, wherein initially segmenting the image into the initial regions further comprises:
resetting a new seed threshold to a first discrete level of a series of discrete gray levels;
as a reentry part of the method, increasing the dynamic color gradient threshold to a next gray level;
locating a plurality of first areas of the image adjacent to seeds including the initial seeds, each first area encompassing a number of the pixels of the image;
for each first area located, the first area being adjacent to a given seed, merging the first area to the initial region within which the given seed is assigned where the first area is similar to the initial region within which the given current seed is assigned; and,
where the initial regions encompass all the pixels of the image, concluding initial segmentation of the image into the initial regions.

6. The method of claim 5, wherein initially segmenting the image into the initial regions further comprises, where the initial regions do not encompass all the pixels of the image:
where one or more pixels of the image exceed the dynamic color gradient threshold, repeating the method starting at the reentry part of the method;
where none of the pixels of the image exceed the dynamic color gradient threshold,
locating a plurality of second areas of the image not adjacent to the current seeds based on the new seed threshold, each second area including a new seed such that there is a plurality of new seeds, the seeds that include the initial seeds now also including the new seeds;
setting the dynamic gradient threshold to the new seed threshold and advancing the new seed threshold to a next discrete gray level within the series of discrete gray levels; and,
repeating the method starting at the reentry part of the method.

7. The method of claim 1, wherein the quantized colors of the image comprises a plurality of discrete colors of the image, each discrete color corresponding to a range of color values.

8. The method of claim 1, wherein generating the texture channel comprises:
quantizing the image into the quantized colors; and,
applying a two-dimensional entropy filter to the quantized colors of the image to generate the texture channel of the image.

9. The method of claim 1, wherein multimodal merging the initial regions based on the color channels and the texture channel of the image, to yield the merged regions corresponding to segmentation of the image, comprises:
performing a multivariate analysis of variance of the color channels and the texture channel of the image within each initial region, the multivariate analysis of variance providing a distance value for each of a plurality of pairs of initial regions; and,
merging the initial regions to yield the merged regions corresponding to segmentation of the image, based on the distance values of the pairs of initial regions.

10. The method of claim 9, wherein the multivariate analysis of variance comprises a one-way multivariate analysis of variance, and the distance values comprise Mahalanobis squared distance values.

11. The method of claim 1, wherein multimodal merging the initial regions based on the color channels and the texture channel of the image, to yield the merged regions corresponding to segmentation of the image, comprises:
setting a plurality of working regions as the initial regions into which the image has been initially segmented;
as a reentry point of the method, performing a multivariate analysis of variance of the color channels and the texture channel of the image within each working region, the multivariate analysis of variance providing a distance value for each of a plurality of pairs of working regions;
selecting a predetermined number of pairs of working regions that have smallest distances values, the predetermined number of pairs of working regions referring to as a current set;
ordering the predetermined number of pairs within the current set from the pair of working regions of the current set that encompasses a smallest number of pixels to the pair of working regions of the current set that encompasses a largest number of pixels; and,
merging the working regions of the pair of working regions within the current set that encompasses the smallest number of pixels to yield a new working region replacing the working regions of pair of working regions within the current set that encompasses the smallest number of pixels.

12. The method of claim 11, wherein multimodal merging the initial regions based on the color channels and the texture channel of the image, to yield the merged regions corresponding to segmentation of the image, further comprises:
for each given pair of working regions of the current set other than the pair of working regions of the current set that encompasses the smallest number of pixels,
where a first working region of the given pair is encompassed by a previously generated new working region, merging a second working region of the given pair into the previously generated new working region where the second working region is not already encompassed by the previously generated new working region;
where neither the first working region of the given pair nor the second working region of the given pair is encompassed by a previously generated new working region, merging the working regions of the given pair to yield another new working region replacing the working regions of the given pair;
where the working regions in number are greater than a desired number of regions into which the image is to be segmented, repeating the method starting at the reentry point of the method; and,
where the working regions in number are not greater than the desired number of regions into which the image is to be segmented, concluding segmentation of the image such that the working regions are the merged regions of the image corresponding to segmentation of the image.

13. A computer-readable medium having one or more computer programs stored thereon to perform a method for segmenting an image comprising:
initially segmenting the image into a plurality of initial regions at least by dynamically selecting a plurality of seeds within the image using a dynamic color gradient threshold and growing the initial regions from the seeds until the initial regions encompass all the pixels of the image, the image having a plurality of pixels and a plurality of color channels;
quantizing the image into a plurality of quantized colors;
applying a two-dimensional entropy filter to the quantized colors of the image to generate a texture channel of the image; and,
multimodal-merging the initial regions into which the image has been initially segmented based on the color channels and the texture channel of the image, to yield a plurality of merged regions corresponding to segmentation of the image.

14. The computer-readable medium of claim 13, wherein multimodal merging the initial regions based on the color channels and the texture channel of the image, to yield the merged regions corresponding to segmentation of the image, comprises:
performing a multivariate analysis of variance of the color channels and the texture channel of the image within each initial region, the multivariate analysis of variance providing a distance value for each of a plurality of pairs of initial regions; and,
merging the initial regions to yield the merged regions corresponding to segmentation of the image, based on the distance values of the pairs of initial regions.

15. A computer-readable medium having one or more computer programs stored thereon to perform a method for segmenting an image comprising:
initially segmenting the image into a plurality of initial regions at least by dynamically selecting a plurality of seeds within the image using a dynamic color gradient threshold and growing the initial regions from the seeds until the initial regions encompass all the pixels of the image, the image having a plurality of pixels and a plurality of color channels;
generating a texture channel of the image at least by applying an entropy filter to each of a plurality of quantized colors of the image;
performing a multivariate analysis of variance of the color channels and the texture channel of the image within each initial region, the multivariate analysis of variance providing a distance value for each of a plurality of pairs of initial regions; and,
merging the initial regions to yield the merged regions corresponding to segmentation of the image, based on the distance values of the pairs of initial regions.

16. The computer-readable medium of claim 15, wherein the multivariate analysis of variance comprises a one-way multivariate analysis of variance, and the distance values comprise Mahalanobis squared distance values.

17. The computer-readable medium of claim 15, wherein performing the multivariate analysis of variance and merging the initial regions to yield the merged regions comprises:
setting a plurality of working regions as the initial regions into which the image has been initially segmented;
as a reentry point of the method, performing a multivariate analysis of variance of the color channels and the texture channel of the image within each working region, the multivariate analysis of variance providing a distance value for each of a plurality of pairs of working regions;
selecting a predetermined number of pairs of working regions that have smallest distances values, the predetermined number of pairs of working regions referring to as a current set;
ordering the predetermined number of pairs within the current set from the pair of working regions of the current set that encompasses a smallest number of pixels to the pair of working regions of the current set that encompasses a largest number of pixels;
merging the working regions of the pair of working regions within the current set that encompasses the smallest number of pixels to yield a new working region replacing the working regions of pair of working regions within the current set that encompasses the smallest number of pixels;
for each given pair of working regions of the current set other than the pair of working regions of the current set that encompasses the smallest number of pixels,
where a first working region of the given pair is encompassed by a previously generated new working region, merging a second working region of the given pair into the previously generated new working region where the second working region is not already encompassed by the previously generated new working region;
where neither the first working region of the given pair nor the second working region of the given pair is encompassed by a previously generated new working region, merging the working regions of the given pair to yield another new working region replacing the working regions of the given pair;
where the working regions in number are greater than a desired number of regions into which the image is to be segmented, repeating the method starting at the reentry point of the method; and,
where the working regions in number are not greater than the desired number of regions into which the image is to be segmented, concluding segmentation of the image such that the working regions are the merged regions of the image corresponding to segmentation of the image.
